(19) United States
(12) Patent Application Publication
(10) Pub. No.: US 2024/0093058 A1
(43) Pub. Date: Mar. 21, 2024

(54) POLYSILAZANE HARD COATING COMPOSITIONS

(71) Applicant: MERCK PATENT GMBH, Darmstadt (DE)

(72) Inventors: Ralf GROTTENMUELLER, Darmstadt (DE); Sergej NELL, Darmstadt (DE); Patrizia LACHNIT, Darmstadt (DE); Thomas KRASEMANN, Darmstadt (DE)

(73) Assignee: MERCK PATENT GMBH, Darmstadt (DE)

(21) Appl. No.: 18/270,562

(22) PCT Filed: Jan. 5, 2022
(86) PCT No.: PCT/EP2022/050104

§ 371 Date: Jun. 30, 2023

(30) Foreign Application Priority Data
Jan. 8, 2021 (EP) 21150705.8

(51) Int. Cl. C09D 183/16; C09D 7/61

(52) U.S. Cl. CPC C09D 183/16; C09D 7/61; C08K 3/36; C08K 2201/003

(57) ABSTRACT

The present invention relates to coating compositions which comprise a silazane polymer (A), a silane coupling agent (B); and inorganic nanoparticles (C), wherein the components (A), (B) and (C) are present in certain ratios. The coating compositions are particularly suitable for the preparation of hard coatings on surfaces of various base material substrates.

### TECHNICAL FIELD

The present invention relates to coating compositions which comprise a silazane polymer (A), a silane coupling agent (B); and an inorganic nanoparticles (C), wherein the components (A), (B) and (C) are present in certain ratios. The coating compositions are particularly suitable for the preparation of hard coatings on surfaces of various base material substrates. The hard coatings provide improved physical and chemical surface properties such as, for example, improved mechanical resistance and durability (including improved surface hardness, improved scratch resistance and/or improved abrasion resistance); improved wetting and adhesion properties (including hydro- and oleophobicity, easy-to-clean effect and/or anti-graffiti effect); improved chemical resistance (including improved corrosion resistance (e.g. against solvents, acidic and alkaline media and corrosive gases and/or improved anti-oxidation effect); and improved physical barrier or sealing effects.

The coating compositions according to the present invention allow the preparation of hard coatings having maximum mechanical resistance and durability such as, in particular, maximum surface hardness, scratch resistance and abrasion resistance. In addition, adverse behavior such as formation of turbid films and wetting problems is avoided.

Furthermore, the coating compositions according to the present invention show high adhesion to various substrate surfaces and allow an easy application by user-friendly coating methods so that hard coatings may be obtained in an efficient and easy manner.

The present invention further relates to a method for preparing a coated article using said coating composition and to a coated article, which is prepared by said method. There is further provided for the use of said coating composition for forming a hard coating on the surface of a base material, thereby improving one or more of the above-mentioned surface properties.

### BACKGROUND OF THE INVENTION

Polymers containing silazane repeating units —[SiR₂—NR′-] are typically referred to as polysilazanes. If all substituents R and R′ are hydrogen, the material is called perhydropolysilazane (PHPS) and, if at least one of R and R′ is an organic moiety, the material is called organopolysilazane (OPSZ). PHPS and OPSZ are used for a variety of functional coatings to impart certain properties to surfaces, such as e.g. anti-graffiti effect, scratch resistance, corrosion resistance or hydro- and oleophobicity. Hence, silazanes are widely used for functional coatings for various applications.

Whilst polysilazanes are composed of one or more different silazane repeating units, polysiloxazanes additionally contain one or more different siloxane repeating units. Polysiloxazanes combine features of polysilazane and polysiloxane chemistry and behavior. Polysilazanes and polysiloxazanes are resins that are used for the preparation of functional coatings for different types of application.

Typically, both polysilazanes and polysiloxazanes are liquid polymers which become solid at molecular weights of ca. >10,000 g/mol. In most applications, liquid polymers of moderate molecular weights, typically in the range from 2,000 to 8,000 g/mol, are used. For preparing solid coatings from such liquid polymers, a curing step is required which is carried out after applying the material on a substrate, either as a pure material or as a formulation.

Polysilazanes or polysiloxazanes can be crosslinked by hydrolysis, for example, by reaction with moisture from the air. This leads to an increasing molecular weight and to a solidification or curing of the material. For this reason, the terms “curing” and “crosslinking” and the corresponding verbs “cure” and “crosslink” are interchangeably used as synonyms in the present application when referred to silazane based polymers such as e.g. polysilazanes and polysiloxazanes. Usually, curing is performed by hydrolysis under ambient conditions or at elevated temperatures. Cured polysilazanes show excellent adhesion, high hardness and good scratch resistance.

One of the unique properties of polysilazane based coatings is their high crosslinking density after full curing. As a result, such coatings have high a high hardness and are applied as hard coats for scratch protection, especially on soft material like plastics. To increase the speed of curing by moisture in ambient atmosphere, low molecular weight alkoxysilanes (silane coupling agents) such as e.g. H₂N—(CH₂)₃—Si(OEt)₃(i.e. 3-aminopropyltriethoxysilane, AMEO) or (MeO)₃Si—(CH₂)₃—NH—(CH₂)₃—Si(OMe)₃ (i.e. bis[3-(trimethoxysilyl)propyl]amine, AMEO-Dimer) are added. Such additives also increase hardness after full curing. Another frequently used approach for increasing hardness and scratch resistance of polysilazane based coatings is the addition of nanoparticles. If the coating is to remain optically transparent, the size of the nanoparticles should have a diameter of ≤20 nm. Inorganic nanoparticles are typically used and inorganic oxide nanoparticles are most commonly used. Silicon oxide nanoparticles are particularly preferred, because they perform well and are easily commercially available.

US 2003/0083453 A1 relates to moisture curable polysiloxazanes and polysilazanes used for the preparation of surface coatings, which are prepared by heating polysilazanes or polysiloxazanes in the presence of an alkoxy silyl reagent. Moreover, the incorporation of ceramic powders and glasses is suggested for obtaining harder coatings.

US 2020/0199406 A1 relates to transparent coating film compositions based on polysilazanes and to the use of AMEO as catalyst for such compositions.

WO 2007/028511 A2 relates to the use of polysilazanes as permanent coatings on metal and polymer surfaces to prevent corrosion, increase scratch resistance and facilitate easier cleaning. Inorganic nanoparticles such as e.g. SiO₂, TiO₂, ZnO, ZrO₂ or Al₂O₃ are described as further component of such polysilazane formulations. In addition, a catalytic use of AMEO is described in the examples.

CN 108727979 A relates to coating compositions comprising perhydro-polysilazane, siloxane, inorganic particles, an optional catalyst and an optional silane coupling agent. The coating compositions are used for forming coating layers on the surface of a base material with good adhesion, temperature resistance and scratch resistance as well as low-energy surface characteristics and easy-to-clean property.

EP 3546498 A1 relates to polysilazane compositions comprising an organopolysilazane compound free of Si—H structure and an organoxysilane compound having at least two silicon atoms in the molecule such as e.g. bis(trimethoxysilylpropyl)amine or bis(triethoxysilylpropyl)amine.

Although the above-mentioned coating compositions and surface coatings prepared therefrom show some advantageous properties such as e.g. good chemical or mechanical resistance, they do not satisfy the requirements of modern high-performance surface coatings as regards the combination of high mechanical resistance, chemical resistance and durability. For this reason, there is a constant need to further improve the surface coating compositions known from the state of the art, especially for hard coating applications.

Object of the Invention

Hence, it is an object of the present invention to overcome the disadvantages in the prior art and to provide new coating compositions, which are particularly suitable for the preparation of hard coatings on surfaces of various base material substrates to provide improved physical and chemical surface properties such as, for example, improved mechanical resistance and durability (including improved surface hardness, improved scratch resistance and/or improved abrasion resistance); improved wetting and adhesion properties (including hydro- and oleophobicity, easy-to-clean effect and/or anti-graffiti effect); improved chemical resistance (including improved corrosion resistance (e.g. against solvents, acidic and alkaline media and corrosive gases and/or improved anti-oxidation effect); and improved physical barrier or sealing effects.

In particular, it is desirable to provide new coating compositions allowing the preparation of hard coatings having maximum mechanical resistance and durability such as maximum surface hardness, scratch resistance and abrasion resistance. In addition, it is desirable to avoid adverse behavior such as formation of turbid films and wetting problems.

Furthermore, it is an object of the present invention to provide new coating compositions which, in addition to the above-mentioned advantages, show high adhesion to various substrate surfaces and allow an easy application by user-friendly coating methods so that hard coatings may be obtained in an efficient and easy manner.

It is a further object of the present invention to provide a method for preparing a coated article and a coated article being prepared by said method and showing the above-mentioned advantages.

5

Finally, it is an object of the present invention to provide coating compositions, which can be used for forming hard coatings on surfaces of various base materials to improve one or more of the aforementioned surface properties, specifically surface hardness, scratch resistance and abrasion resistance.

### SUMMARY OF THE INVENTION

The present inventors surprisingly found that coating compositions comprising a silazane polymer (A); a silane coupling agent (B); and inorganic nanoparticles (C), where the components are present in certain mixing ratios, solve the above-mentioned objects and provide, in particular, surface coatings having high hardness, high scratch resistance and high abrasion resistance.

Taking this into account, the present inventors surprisingly found that the above objects are solved, either individually or in any combination, by a coating composition, comprising:

(i) a silazane polymer (A);

(ii) a silane coupling agent (B); and

(iii) inorganic nanoparticles (C);

wherein the weight ratio [A]:[β] of the silazane polymer (A) to the silane coupling (B) is in the range from 75:25 to 40:60, and the weight ratio [A+B]:[C] of the silazane polymer (A) and the silane coupling agent (B) to the inorganic nanoparticles (C) is in the range from 80:20 to 50:50.

In addition, a method for preparing a coated article is provided, wherein the method comprises the following steps:
(a) applying a coating composition according to the present invention to a surface of an article; and
(b) curing said coating composition to obtain a coated article.

Moreover, a coated article is provided, which is obtainable or obtained by the above-mentioned method for preparing a coated article according to the present invention.

The present invention further relates to the use of a coating composition according to the present invention for forming a hard coating on a surface of a base material.

Preferred embodiments of the invention are described in the dependent claims.

### BRIEF DESCRIPTION OF THE FIGURES

FIG. 1: Analytical results Exp.1-A1—Exp.1-D6 of coatings derived from formulations 1-A1 to 1-D6.

FIG. 2: Analytical results Exp.2-A1—Exp.2-D6 of coatings derived from formulations 2-A1 to 2-D6.

FIG. 3: Analytical results Exp.3-A1—Exp.3-C5 of coatings derived from formulations 3-A1 to 3-C5.

### DETAILED DESCRIPTION

Definitions

The term “polymer” includes, but is not limited to, homopolymers, copolymers, for example, block, random, and alternating copolymers, terpolymers, quaterpolymers, etc., and blends and modifications thereof. Furthermore, unless otherwise specifically limited, the term “polymer” shall include all possible configurational isomers of the material. These configurations include, but are not limited to isotactic, syndiotactic, and atactic symmetries. A polymer is a molecule of high relative molecular mass, the structure of which essentially comprises the multiple repetition of units (i.e. repeating units) derived, actually or conceptually, from molecules of low relative mass (i.e. monomers). Typically, the number of repeating units is higher than 10, preferably higher than 20, in polymers. If the number of repeating units is less than 10, the polymers may also be referred to as oligomers.

The term “monomer” as used herein, refers to a molecule which can undergo polymerization thereby contributing constitutional units (repeating units) to the essential structure of a polymer.

The term “homopolymer” as used herein, stands for a polymer derived from one species of (real, implicit or hypothetical) monomer.

The term “copolymer” as used herein, generally means any polymer derived from more than one species of monomer, wherein the polymer contains more than one species of corresponding repeating unit. In one embodiment the copolymer is the reaction product of two or more species of monomer and thus comprises two or more species of corresponding repeating unit. It is preferred that the copolymer comprises two, three, four, five or six species of repeating unit. Copolymers that are obtained by copolymerization of three monomer species can also be referred to as terpolymers. Copolymers that are obtained by copolymerization of four monomer species can also be referred to as quaterpolymers. Copolymers may be present as block, random, and/or alternating copolymers.

The term “block copolymer” as used herein, stands for a copolymer, wherein adjacent blocks are constitutionally different, i.e. adjacent blocks comprise repeating units derived from different species of monomer or from the same species of monomer but with a different composition or sequence distribution of repeating units.

Further, the term “random copolymer” as used herein, refers to a polymer formed of macromolecules in which the probability of finding a given repeating unit at any given site in the chain is independent of the nature of the adjacent repeating units. Usually, in a random copolymer, the sequence distribution of repeating units follows Bernoullian statistics.

The term “alternating copolymer” as used herein, stands for a copolymer consisting of macromolecules comprising two species of repeating units in alternating sequence.

The term “polysilazane” as used herein, refers to a polymer in which silicon and nitrogen atoms alternate to form the basic backbone. Since each silicon atom is bound to at least one nitrogen atom and each nitrogen atom to at least one silicon atom, both chains and rings of the general formula —[SiR¹R²—NR³—]ₘ (silazane repeating unit) occur, wherein R¹ to R³ may be hydrogen atoms, organic substituents or hetero-organic substituents; and m is an integer. If all substituents R¹ to R³ are hydrogen atoms, the polymer is designated as perhydropolysilazane, polyperhydrosilazane or inorganic polysilazane (—[SiH₂—NH—]ₘ). If at least one substituent R¹ to R³ is an organic or hetero-organic substituent, the polymer is designated as organopolysilazane.

The term “polysiloxazane” as used herein, refers to a polysilazane which additionally contains sections in which silicon and oxygen atoms alternate. Such sections may be represented, for example, by —[O—SiR⁷R⁸—]ₙ, wherein R⁷ and R⁸ may be hydrogen atoms, organic substituents, or hetero-organic substituents; and n is an integer. If all substituents of the polymer are hydrogen atoms, the polymer is designated as perhydropolysiloxazane. If at least one substituents of the polymer is an organic or hetero-organic substituent, the polymer is designated as organopolysiloxazane.

The term “functional coating” as used herein refers to coatings which impart one or more specific properties to a surface. Generally, coatings are needed to protect surfaces or impart specific effects to surfaces. There are various effects which may be imparted by functional coatings. For example, mechanical resistance, surface hardness, scratch resistance, abrasion resistance, anti-microbial effect, anti-fouling effect, wetting effect (towards water), hydro-and oleophobicity, smoothening effect, durability effect, antistatic effect, anti-staining effect, anti-fingerprint effect, easy-to-clean effect, anti-graffiti effect, chemical resistance, corrosion resistance, anti-oxidation effect, physical barrier effect, sealing effect, heat resistance, fire resistance, low shrinkage, UV-barrier effect, light fastness, and/or optical effects.

The term “cure” means conversion to a crosslinked polymer network (for example, through heat or irradiation with or without catalysis).

The term “silane coupling agent” as used herein refers to a compound having the ability to form a durable bond between organic and inorganic materials. Typical silane coupling agents generally show two classes of functionality:

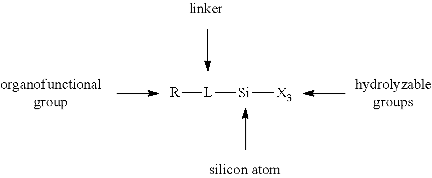

X is a hydrolysable group typically alkoxy, acyloxy, halogen or amine. Following hydrolysis, a reactive silanol group is formed, which can condense with other silanol groups, for example, those being formed during hydrolysis of polysilazanes, to form siloxane linkages. R is a non-hydrolyzable organofunctional group that may possess a functionality imparting desired characteristics. In the context of the present invention, a silane coupling agent is an alkoxysilane compound containing one or more alkoxy silyl groups as described further below. A silane coupling agent may also be referred to as alkoxy silyl reagent.

The term “structural unit” as used herein, refers to a structural molecular unit having one, two, three or more binding sites.

The term “alkyl” as used herein, means a linear, branched or cyclic alkyl group which may be substituted.

The term “aryl” as used herein, means any mono-, bi-, tri- or polycyclic aromatic or heteroaromatic group, which may be substituted. Heteroaromatic groups contain one or more heteroatoms (e.g. N, O, S and/or P) in the heteroaromatic system.

The term “arylalkyl” as used herein, means any univalent radical derived from an alkyl radical by replacing one or more hydrogen atoms by aryl groups.

Preferred Embodiments

The present invention relates to a coating composition, comprising:
(i) a silazane polymer (A);
(ii) a silane coupling agent (B); and
(iii) inorganic nanoparticles (C);

wherein the weight ratio [A]:[B] of the silazane polymer (A) to the silane coupling (B) is in the range from 75:25 to 40:60, and the weight ratio [A+B]:[C] of the silazane polymer (A) and the silane coupling agent (B) to the inorganic nanoparticles (C) is in the range from 80:20 to 50:50.

Silazane Polymer (A)

In a preferred embodiment of the present invention, the silazane polymer (A) comprises a repeating unit M¹ represented by Formula (1):

—[SIR¹R²—NR³—] Formula (1)

wherein R¹, R² and R³ are the same or different from each other and independently selected from hydrogen, an organic group, or a hetero-organic group.

Suitable organic and hetero-organic groups for R¹, R² and R³ include alkyl, alkylcarbonyl, alkenyl, cycloalkyl, aryl, arylalkyl, alkylsilyl, alkylsilyloxy, arylsilyl, arylsilyloxy, alkylamino, arylamino, alkoxy, alkoxycarbonyl, alkylcarbonyloxy, aryloxy, aryloxycarbonyl, arylcarbonyloxy, arylalkyloxy, and the like, and combinations thereof (preferably, alkyl, alkenyl, cycloalkyl, aryl, arylalkyl, alkoxy, aryloxy, arylalkyloxy, and combinations thereof); the groups preferably having from 1 to 30 carbon atoms (more preferably, 1 to 20 carbon atoms; even more preferably, 1 to 10 carbon atoms; most preferably, 1 to 6 carbon atoms (for example, methyl, ethyl or vinyl)). The groups can be further substituted with one or more substituents such as halogen (fluorine, chlorine, bromine, and iodine), alkoxy, alkoxycarbonyl, amino, carboxyl, hydroxyl, nitro, and the like, and combinations thereof.

In a preferred embodiment, R¹ and R² are the same or different from each other and independently selected from hydrogen, alkyl having 1 to 30 (preferably 1 to 20, more preferably 1 to 10, most preferably 1 to 6) carbon atoms, alkenyl having 2 to 30 (preferably 2 to 20, more preferably 2 to 10, most preferably 2 to 6) carbon atoms, or aryl having 2 to 30 (preferably 3 to 20, more preferably 4 to 10, most preferably 6) carbon atoms, wherein one or more hydrogen atoms bonded to carbon atoms may be replaced by fluorine; and R³ is selected from hydrogen, alkyl having 1 to 30 (preferably 1 to 20, more preferably 1 to 10, most preferably 1 to 6) carbon atoms, alkenyl having 2 to 30 (preferably 2 to 20, more preferably 2 to 10, most preferably 2 to 6) carbon atoms, or aryl having 2 to 30 (preferably 3 to 20, more preferably 4 to 10, most preferably 6) carbon atoms, wherein one or more hydrogen atoms bonded to carbon atoms may be replaced by fluorine.

In a more preferred embodiment, R¹ and R² are the same or different from each other and independently selected from hydrogen, methyl, ethyl, propyl, butyl, pentyl, hexyl or phenyl, wherein one or more hydrogen atoms bonded to carbon atoms may be replaced by fluorine; and R³ is selected from hydrogen, methyl, ethyl, propyl, butyl, pentyl, hexyl, vinyl or phenyl, wherein one or more hydrogen atoms bonded to carbon atoms may be replaced by fluorine.

In a particularly preferred embodiment, R¹ and R² are the same or different from each other and independently selected from the list consisting of —H, —CH₃, —CH₂CH₃, —CH₂CH₂CH₃, —CH(CH₃)₂, —CH═CH₂, and —C₆H₅, wherein one or more hydrogen atoms bonded to carbon atoms may be replaced by fluorine; and R³ is selected from the list consisting of —H, —CH₃, —CH₂CH₃, —CH₂CH₂CH₃, —CH(CH₃)₂, —CH═CH₂, and —C₆H₅, wherein one or more hydrogen atoms bonded to carbon atoms may be replaced by fluorine.

In a most preferred embodiment, R¹ and R² are the same or different from each other and independently selected from —H and —CH₃, wherein the number ratio of H:CH₃ in the silazane polymer (A) is preferably in the range from 100:0 to 10:90, more preferably in the range from 60:40 to 25:75.

In a preferred embodiment of the present invention, the silazane polymer (A) further comprises a repeating unit M² represented by Formula (2):

—[SiR⁴R⁵—NR⁶—] Formula (2)

wherein R⁴, R⁵ and R⁶ are the same or different from each other and independently selected from hydrogen, an organic group, or a hetero-organic group.

Suitable organic and hetero-organic groups for R⁴, R⁵ and R⁶ include alkyl, alkylcarbonyl, alkenyl, cycloalkyl, aryl, arylalkyl, alkylsilyl, alkylsilyloxy, arylsilyl, arylsilyloxy, alkylamino, arylamino, alkoxy, alkoxycarbonyl, alkylcarbonyloxy, aryloxy, aryloxycarbonyl, arylcarbonyloxy, arylalkyloxy, and the like, and combinations thereof (preferably, alkyl, alkenyl, cycloalkyl, aryl, arylalkyl, alkoxy, aryloxy, arylalkyloxy, and combinations thereof); the groups preferably having from 1 to 30 carbon atoms (more preferably, 1 to 20 carbon atoms; even more preferably, 1 to 10 carbon atoms; most preferably, 1 to 6 carbon atoms (for example, methyl, ethyl or vinyl)). The groups can be further substituted with one or more substituents such as halogen (fluorine, chlorine, bromine, and iodine), alkoxy, alkoxycarbonyl, amino, carboxyl, hydroxyl, nitro, and the like, and combinations thereof.

In a preferred embodiment, R⁴ and R⁵ are the same or different from each other and independently selected from hydrogen, alkyl having 1 to 30 (preferably 1 to 20, more preferably 1 to 10, most preferably 1 to 6) carbon atoms, alkenyl having 2 to 30 (preferably 2 to 20, more preferably 2 to 10, most preferably 2 to 6) carbon atoms, or aryl having 2 to 30 (preferably 3 to 20, more preferably 4 to 10, most preferably 6) carbon atoms, wherein one or more hydrogen atoms bonded to carbon atoms may be replaced by fluorine; and R⁶ is selected from hydrogen, alkyl having 1 to 30 (preferably 1 to 20, more preferably 1 to 10, most preferably 1 to 6) carbon atoms, alkenyl having 2 to 30 (preferably 2 to 20, more preferably 2 to 10, most preferably 2 to 6) carbon atoms, or aryl having 2 to 30 (preferably 3 to 20, more preferably 4 to 10, most preferably 6) carbon atoms, wherein one or more hydrogen atoms bonded to carbon atoms may be replaced by fluorine.

In a more preferred embodiment, R⁴ and R⁵ are the same or different from each other and independently selected from hydrogen, methyl, ethyl, propyl, butyl, pentyl, hexyl or phenyl, wherein one or more hydrogen atoms bonded to carbon atoms may be replaced by fluorine; and R⁶ is selected from hydrogen, methyl, ethyl, propyl, butyl, pentyl, hexyl, vinyl or phenyl, wherein one or more hydrogen atoms bonded to carbon atoms may be replaced by fluorine.

In a most preferred embodiment, R⁴ and R⁵ are the same or different from each other and independently selected from the list consisting of —H, —CH₃, —CH₂CH₃, —CH₂CH₂CH₃, —CH(CH₃)₂, —CH═CH₂, and —C₆H₅, wherein one or more hydrogen atoms bonded to carbon atoms may be replaced by fluorine; and R⁶ is selected from the list consisting of —H, —CH₃, —CH₂CH₃, —CH₂CH₂CH₃, —CH(CH₃)₂, —CH═CH₂, and —C₆H₅, wherein one or more hydrogen atoms bonded to carbon atoms may be replaced by fluorine.

In a preferred embodiment of the present invention, the silazane polymer (A) further comprises a repeating unit M³ represented by Formula (3):

—[SiR⁷R⁸—O—] Formula (3)

wherein R⁷ and R⁸ are the same or different from each other and independently selected from hydrogen, an organic group, or a hetero-organic group.

Suitable organic and hetero-organic groups for R⁷ and R⁸ include alkyl, alkylcarbonyl, alkenyl, cycloalkyl, aryl, arylalkyl, alkylsilyl, alkylsilyloxy, arylsilyl, arylsilyloxy, alkylamino, arylamino, alkoxy, alkoxycarbonyl, alkylcarbonyloxy, aryloxy, aryloxycarbonyl, arylcarbonyloxy, arylalkyloxy, and the like, and combinations thereof (preferably, alkyl, alkenyl, cycloalkyl, aryl, arylalkyl, alkoxy, aryloxy, arylalkyloxy, and combinations thereof); the groups preferably having from 1 to 30 carbon atoms (more preferably, 1 to 20 carbon atoms; even more preferably, 1 to 10 carbon atoms; most preferably, 1 to 6 carbon atoms (for example, methyl, ethyl or vinyl)). The groups can be further substituted with one or more substituents such as halogen (fluorine, chlorine, bromine, and iodine), alkoxy, alkoxycarbonyl, amino, carboxyl, hydroxyl, nitro, and the like, and combinations thereof.

In a preferred embodiment, R⁷ and R⁸ are the same or different from each other and independently selected from hydrogen, alkyl having 1 to 30 (preferably 1 to 20, more preferably 1 to 10, most preferably 1 to 6) carbon atoms, alkenyl having 2 to 30 (preferably 2 to 20, more preferably 2 to 10, most preferably 2 to 6) carbon atoms, or aryl having 2 to 30 (preferably 3 to 20, more preferably 4 to 10, most preferably 6) carbon atoms, wherein one or more hydrogen atoms bonded to carbon atoms may be replaced by fluorine.

In a more preferred embodiment, R⁷ and R⁸ are the same or different from each other and independently selected from hydrogen, methyl, ethyl, propyl, butyl, pentyl, hexyl or phenyl, wherein one or more hydrogen atoms bonded to carbon atoms may be replaced by fluorine.

In a most preferred embodiment, R⁷ and R⁸ are the same or different from each other and independently selected from the list consisting of —H, —CH₃, —CH₂CH₃, —CH₂CH₂CH₃, —CH(CH₃)₂, —CH═CH₂, and —C₆H₅, wherein one or more hydrogen atoms bonded to carbon atoms may be replaced by fluorine.

It is preferred that the silazane polymer comprises a repeating unit M¹ and a further repeating unit M², wherein M¹ and M² are silazane repeating units, which are different from each other.

It is also preferred that the silazane polymer comprises a repeating unit M¹ and a further repeating unit M³, wherein M¹ is a silazane repeating unit and M³ is a siloxane repeating unit.

It is also preferred that the silazane polymer comprises a repeating unit M¹, a further repeating unit M² and a further repeating unit M³, wherein M¹ and M² are silazane repeating units, which are different from each other, and M³ is a siloxane repeating unit.

In one embodiment, the silazane polymer is a polysilazane, which may be a perhydropolysilazane or an organopolysilazane. Preferably, the polysilazane contains a repeating unit M¹ and optionally a further repeating unit M², wherein M¹ and M² are silazane repeating units, which are different from each other.

In an alternative embodiment, the silazane polymer is a polysiloxazane, which may be a perhydropolysiloxazane or an organopolysiloxazane. Preferably, the polysiloxazane contains a repeating unit M¹ and a further repeating unit M³, wherein M¹ is a silazane repeating unit and M³ is a siloxane repeating unit. Preferably, the polysiloxazane contains a repeating unit M¹, a further repeating unit M² and a further repeating unit M³, wherein M¹ and M² are silazane repeating units, which are different from each other, and M³ is a siloxane repeating unit.

Preferably, the silazane polymer is a copolymer such as a random copolymer or a block copolymer or a mixed random block copolymer containing at least one random section and at least one block section. More preferably, the silazane polymer is a random copolymer or a block copolymer.

It is preferred that the silazane polymers used in the present invention do not have a monocyclic structure. More preferably, the silazane polymers have a mixed polycyclic, linear and/or branched-chain structure.

The silazane polymers have a molecular weight distribution. Preferably, the silazane polymers used in the coating composition of the present invention have a mass average molecular weight M_{w}, as determined by GPC, of at least 1,000 g/mol, more preferably of at least 1,200 g/mol, even more preferably of at least 1,500 g/mol. Preferably, the mass average molecular weight M_{w} of the silazane polymers is less than 100,000 g/mol. More preferably, the molecular weight M_{w} of the silazane polymers is in the range from 1,500 to 50,000 g/mol.

Preferably, the total content of the silazane polymer in the coating composition is in the range from 10 to 90 wt.-%, preferably from 20 to 60 wt.-%, based on the total weight of the coating composition.

Silane Coupling Agent (B)

It is preferred that the silane coupling agent (B), which is comprised in the coating composition according to the present invention, comprises one or more alkoxy silyl groups. More preferably, the silane coupling agent (B), which is comprised in the coating composition according to the present invention, comprises one, two, three or four alkoxy silyl groups.

In a preferred embodiment of the present invention, the silane coupling agent (B) is represented by Formula (a):

Z[SiR^{I}₃₋ₖR^{II}ₖ]ₙ Formula (a)

wherein Z is a structural unit comprising one or more carbon and/or silicon atoms;
R^{I} is at each occurrence independently from each other a linear alkoxy group having 1 to 20 carbon atoms, preferably 1 to 10 carbon atoms, more preferably 1 to 5 carbon atoms, a branched alkoxy group having 3 to 20 carbon atoms, preferably 3 to 10 carbon atoms, more preferably 3 to 5 carbon atoms, or a cyclic alkoxy group having 3 to 20 carbon atoms, preferably 3 to 10 carbon atoms, more preferably 3 to 6 carbon atoms, which optionally contains one or more —O— and/or —Si(CH₃)₂- groups; R^{II} is at each occurrence independently from each other a linear alkyl group having 1 to 20 carbon atoms, preferably 1 to 10 carbon atoms, more preferably 1 to 5 carbon atoms, a branched alkyl group having 3 to 20 carbon atoms, preferably 3 to 10 carbon atoms, more preferably 3 to 5 carbon atoms, or a cyclic alkyl group having 3 to 20 carbon atoms, preferably 3 to 10 carbon atoms, more preferably 3 to 6 carbon atoms;
k is 0, 1 or 2, preferably 0; and
n is 1, 2, 3 or 4, preferably 1 or 2.

In a more preferred embodiment of the present invention, the silane coupling agent (B) is represented by one of Formulae (b) to (e):

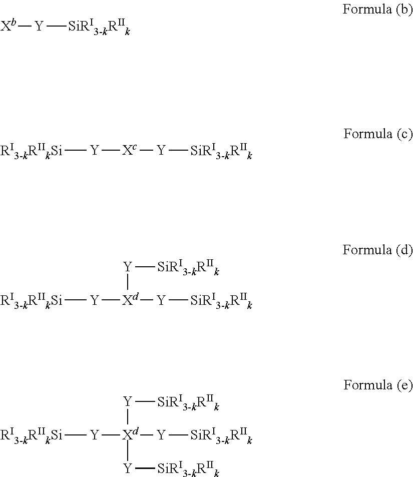

wherein X^{b} is selected from the list consisting of (CH₃)₂N—, [HO—(CH₂)ₘ]₂N—, ACO—, CH₃(CH₂)ₘ—NH—, CH₃—NH—, Cl—, H₂C═C(CH₃)—CH₂—NH—, H₂C═C(CH₃)—CO—O—, H₂C═C(CH₃—O—CH₂—CH(OH)—CH₂—NH—, H₂C═CHv, H₂C═CH—CH₂—NH—, H₂C═CH—CO—CH₂—CH(OH)—CH₂—NH—, H₂C═CH—CO—O—, H₂N—, H₂N—(CH₂)ₘ—NH—, H₂N—(CH₂)ₘ—NH—(CH₂)ₙ—, H₂N—(CH₂)ₘ—NH—(CH₂)ₙ—NH—, H₂N—(CH₂)ₘ—NH—C₄H₆—, H₂N—(CH₂)ₘNH—CH₂—C₄H₆—, H₂N—(CH₂)ₘ—O—C(CH₃)₂—CH═CH—, H₂N—C₆H₄—, H₂N—C₆H₄—O—, H₃C—, H₃C—(CH₂)ₘ—, H₃C—(CH₂)ₘ—O—, H₃CO—, HO—, HS—, NCS—, Ph₂N—, Ph—CO—O—, Ph—NH—, and

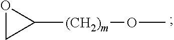

m is an integer from 1 to 10, preferably 1 to 6, more preferably 1 to 3; n is an integer from 1 to 10, preferably 1 to 6, more preferably 1 to 3; X^{c} is selected from the list consisting of —(CH₂)ₚ—, —NH—, —NH—(CH₂)ₚ—NH—, —O—, —S—, —S₂—, —S₃—, —S₄—, —Si(CH₃)₂—, and —Si(CH₃)₂—O—Si(CH₃)₂—; p is an integer from 1 to 20, preferably 1 to 12, more preferably 1 to 8;
X^{d} is selected from the list consisting of

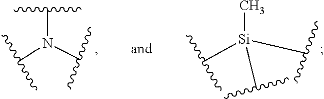

X^{e} is selected from the list consisting of

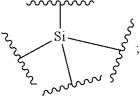 [SMILES: *[Si](*)(*)*]

Y is absent or a linear alkylene group having 1 to 20 carbon atoms, preferably 1 to 10 carbon atoms, more preferably 1 to 5 carbon atoms, a branched alkylene group having 3 to 20 carbon atoms, preferably 3 to 10 carbon atoms, more preferably 3 to 5 carbon atoms, or a cyclic alkylene group having 3 to 20 carbon atoms, preferably 3 to 10 carbon atoms, more preferably 3 to 6 carbon atoms;
R^{I} is at each occurrence independently from each other a linear alkoxy group having 1 to 20 carbon atoms, preferably 1 to 10 carbon atoms, more preferably 1 to 5 carbon atoms, a branched alkoxy group having 3 to 20 carbon atoms, preferably 3 to 10 carbon atoms, more preferably 3 to 5 carbon atoms, or a cyclic alkoxy group having 3 to 20 carbon atoms, preferably 3 to 10 carbon atoms, more preferably 3 to 6 carbon atoms, which optionally contains one or more —O— and/or —Si(CH₃)₂- groups; R^{II} is at each occurrence independently from each other a linear alkyl group having 1 to 20 carbon atoms, preferably 1 to 10 carbon atoms, more preferably 1 to 5 carbon atoms, a branched alkyl group having 3 to 20 carbon atoms, preferably 3 to 10 carbon atoms, more preferably 3 to 5 carbon atoms, or a cyclic alkyl group having 3 to 20 carbon atoms, preferably 3 to 10 carbon atoms, more preferably 3 to 6 carbon atoms; and k is 0, 1 or 2, preferably 0.

The serpentine line in the above structures for X^{d} and X^{e} denotes a binding site.

Preferred silane coupling agents (B) of Formula (b) are selected from the list consisting of:
(3-acryloxypropyl)dimethylmethoxysilane,
(3-acryloxypropyl)methyldimethoxysilane,
(3-acryloxypropyl)trimethoxysilane,
(aminoethylaminomethyl)phenethyltrimethoxysilane,
(methacryloxymethyl)dimethylethoxysilane,
3-(2-aminoethylamino)propylmethyldiethoxysilane,
3-(2-aminoethylamino)propyltrimethoxysilane,
3-(3-am inopropoxy)-3,3-dimethyl-1-propenyl-trimethoxysi lane,
3-(m-aminophenoxy)propyltrimethoxysilane,
3-(N-allylamino)propyltrimethoxysilane, 3-(trimethoxysilyI)-1-propanethiol, 3-aminopropyldimethylethoxysilane, 3-aminopropylmethyldiethoxysilane,
3-aminopropylmethyldimethoxysilane, 3-aminopropyltriethoxysilane,
3-aminopropyltrimethoxysilane,
3-aminopropyltris(methoxyethoxyethoxy)silane,
3-chloropropyltrimethoxysilane, 3-glycidyloxypropyltriethoxysilane,
3-glycidyloxypropyltrimethoxysilane,
3-methacryloxypropyldimethylethoxysilane,
3-methacryloxypropyltriethoxysilane,
3-methacryloxypropyltris(methoxyethoxy)silane,
4-aminobutyltriethoxysilane,
6-ethyl-6-(2-methoxyethoxy)-2,5,7,10-tetraoxa-6-silaundecane, acetoxymethyltriethoxysilane, acetoxymethyltrimethoxysilane, acetoxypropyltrimethoxysilane, benzoyloxypropyltrimethoxysilane, hydroxymethyltriethoxysilane, m-aminophenyltrimethoxysilane, methacryloxymethyltriethoxysilane, methacryloxymethyltrimethoxysilane,
N-(2-aminoethyl)-3-aminoisobutylmethyldimethoxysilane,
N-(2-aminoethyl)-3-aminopropylmethyldimethoxysilane,
N-(2-aminoethyl)-3-aminopropyltrimethoxysilane,
N-(3-acryloxy-2-hydroxypropyl)-3-aminopropyltriethoxysilane,

N-(6-aminohexyl)aminopropyltrimethoxysilane,
N-(n-butyl)-3-aminopropyltrimethoxysilane,
N,N-bis(2-hydroxyethyl)-3-aminopropyltriethoxysilane,
N¹-(3-trimethoxysilylpropyl)diethylenetriamine,
N-methylaminopropylmethyldimethoxysilane,

N-methylaminopropyltrimethoxysilane,
N-phenylaminomethyltriethoxysilane,
N-phenylaminopropyltrimethoxysilane, p-aminophenyltrimethoxysilane, tetraethoxysilane, triethoxy(3-thiocyanato)propylsilane, triethoxy(octyl)silane, trimethoxymethylsilane, and vinyltriethoxysilane.

Preferred silane coupling agents (B) of Formula (c) are selected from the list consisting of:
1-(triethoxysilyl)-2-(diethoxymethylsilyl)ethane,
1-(trimethoxysilyl)-2-(dimethylmethoxysilyl)ethane,
1-(trimethoxysilyl)-2-(methyldimethoxysilyl)ethane,
1,2-bis(dimethylmethoxysilyl)ethane, 1,2-bis(methyldimethoxysilyl)ethane,
1,2-bis(trimethoxysilyl)ethane,
1,3-bis(triethoxysilylethyl)-1,1,3,3-tetramethyldisiloxane,
1,3-bis(trimethoxysilylethyl)-1,1,3,3-tetramethyldisiloxane,
1,6-bis(triethoxysilyl)hexane, 1,6-bis(trimethoxysilyl)hexane,
1,8-bis(triethoxysilyl)octane, 1,8-bis(trimethoxysilyl)octane,
bis(3-(triethoxysilyl)-1-propyl)disulfide,
bis(3-(trimethoxysilyl)-1-propyl)disulfide,
bis(3-(trimethoxysilyl)-1-propyl)tetrasulfide,
bis[2-(triethoxysilyl)ethyl]dimethylsilane, bis[3-(triethoxysilyl)propyl]amine,
bis[3-(triethoxysilyl)propyl]sulfide, bis[2-(trimethoxysilyl)ethyl]dimethylsilane,
bis[3-(trimethoxysilyl)propyl]amine, bis[3-(trimethoxysilyl)propyl]sulfide,
bis[3-(triethoxysilyl)propyl]ether, bis[3-(trimethoxysilyl)propyl]ether, and
N,N′-bis[3-(trimethoxysilyl)propyl]ethylenediamine.

Preferred silane coupling agents (B) of Formula (d) are selected from the list consisting of:
tris(triethoxysilylethyl)methylsilane,
tris(triethoxysilylethyldimethylsiloxy)methylsilane,
tris(triethoxysilylpropyl)amine, tris(triethoxysilylpropyl)methylsilane,
tris(trimethoxysilylethyl)methylsilane,
tris(trimethoxysilylethyldimethylsiloxy)methylsilane,
tris(trimethoxysilylpropyl)amine, and tris(trimethoxysilylpropyl)methylsilane.

Preferred silane coupling agents (B) of Formula (e) are selected from the list consisting of:
tetrakis(triethoxysilylethyl)silane, tetrakis(triethoxysilylpropyl)silane, and
tetrakis(trimethoxysilylpropyl)silane.

Particularly preferred silane coupling agents (B) are 3-aminopropyltrimethoxysilane, 3-aminopropyltriethoxysilane, bis[3-(trimethoxysilyl)propyl]amine, bis[3-(triethoxysilyl)propyl]amine, tris(trimethoxysilylpropyl)amine and tris(triethoxysilylpropyl)amine.

It is preferred that the coating composition according to the present invention comprises one of the above-mentioned silane coupling agents or two, three or more of the above-mentioned silane coupling agents in combination.

Inorganic Nanoparticles (C)

In a preferred embodiment of the present invention, the inorganic nanoparticles (C) are selected from the list consisting of carbides, diamond, nitrides, oxides, silicates, sulfates, sulfides, sulfites, and titanates which are optionally surface-modified with a capping agent.

In a more preferred embodiment of the present invention, the inorganic nanoparticles (C) are selected from the list consisting of boron carbide, silicon carbide, titanium carbide, tungsten carbide, diamond, boron nitride, silicon nitride, titanium nitride, aluminum oxide, molybdenum oxide, silica, titania and zirconia.

In a most preferred embodiment of the present invention, the inorganic nanoparticles (C) are silica (SiO₂).

The coating composition according to the present invention may comprise one, two or more types of the above-mentioned inorganic nanoparticles (C).

Preferably, the inorganic nanoparticles (C) have a particle diameter of ≤100 nm, more preferably ≤60 nm, even more preferably ≤40 nm, and most preferably ≤25 nm. Preferably, the inorganic nanoparticles (C) have a particle diameter in the range from 1 to 100 nm, more preferably from 5 to 60 nm, even more preferably from 10 to 40 nm, and most preferably from 10 to 25 nm. The particle diameter can be determined by any standard method known to the skilled person such as e.g. dynamic light scattering. Devices and methods for determining the size of nanoscale particles are available, for example, from Malvern Panalytical (https://www.malvernpanalytical.com/en/products/product-range/zetasizer-range/zetasizer-advance-range/zetasizer-pro).

Weight Ratios

In the coating composition according to the present invention the weight ratio [A]:[B] of the silazane polymer (A) to the silane coupling (B) is in the range from 75:25 to 40:60, and the weight ratio [A+B]:[C] of the silazane polymer (A) and the silane coupling agent (B) to the inorganic nanoparticles (C) is in the range from 80:20 to 50:50.

It is preferred that the weight ratio [A]:[B] of the silazane polymer (A) to the silane coupling (B) is in the range from 66:34 to 45:55, and the weight ratio [A+B]:[C] of the silazane polymer (A) and the silane coupling agent (B) to the inorganic nanoparticles (C) is in the range from 73:27 to 55:45.

It is more preferred that the weight ratio [A]:[B] of the silazane polymer (A) to the silane coupling (B) is in the range from 60:40 to 50:50, and the weight ratio [A+B]:[C] of the silazane polymer (A) and the silane coupling agent (B) to the inorganic nanoparticles (C) is in the range from 70:30 to 60:40.

Further Components

It is preferred that the coating composition according to the present invention comprises one or more solvents. Suitable solvents are organic solvents such as, for example, aliphatic and/or aromatic hydrocarbons, which may be halogenated, such as 1-chloro-4-(trifluoromethyl)benzene, esters such as ethyl acetate, n-butyl acetate, propylene glycol methyl ether acetate, or tert-butyl acetate, ketones such as acetone or methyl ethyl ketone, ethers such as tetrahydrofuran or dibutyl ether, and also mono- or polyalkylene glycol dialkyl ethers (glymes), or alpha alkyl omega alkyl carbonyl mono or poly glycols such as for example butyldiglycol acetate, or mixtures thereof.

Moreover, the coating composition according to the present invention may comprise one or more additives, preferably selected from the list consisting of additives influencing evaporation behavior, additives influencing film formation, adhesion promoters, anti-corrosion additives, crosslinking agents, dispersants, fillers, functional pigments (e.g. for providing functional effects such as electric or thermal conductivity, magnetic properties, etc.), optical pigments (e.g. for providing optical effects such as color, refractive index, pearlescent effect, etc.), particles reducing thermal expansion, primers, rheological modifiers (e.g. thickeners), surfactants (e.g. wetting and leveling agents or additives for improving hydro- or oleophobicity and anti-graffiti effects), viscosity modifiers, and other kinds of resins or polymers.

It is possible to accelerate the curing of the coating composition by the addition of one or more catalysts. Examples of useful catalysts are Lewis acids such as boron-, aluminum-, tin- or zinc-alkyls, aryls or carboxylates, Bronsted acids such as carboxylic acids, bases such as primary, secondary or tertiary amines or phosphazenes, or metal salts such as Pd, Pt, Al, B, Sn or Zn salts of carboxylates, acetylacetonates or alkoxylates. If silazanes having both Si—H and Si—CH═CH₂ groups are used, well known hydrosilylation catalysts such as Pt or Pd salts or complexes can be used. If silazanes having only Si—CH═CH₂ or both Si—H and Si—CH═CH₂ groups are used, UV or thermal radical initiators like peroxides or azo compounds can be used. In a preferred embodiment, the coating composition according to the present invention comprises one or more of the above-mentioned catalysts.

It is to be understood that the skilled person can freely combine the above-mentioned preferred, more preferred, particularly preferred and most preferred embodiments relating to the coating composition and definitions of its components in any desired way.

Method

The present invention further relates to a method for preparing a coated article, wherein the method comprises the following steps:
(a) applying a coating composition according to the present invention to a surface of an article; and
(b) curing said coating composition to obtain a coated article.

Preferably, the coating composition, which is applied in step (a), is a homogeneous liquid having a viscosity in the range from 0.5 to 1,000 mPas, more preferably from 1 to 250 mPas. The viscosity of the composition may be adjusted by the type and content of solvent as well as the type, ratio and/or molecular weight of the silazane polymer (A), the silane coupling agent (B) and inorganic nanoparticles (C).

It is preferred that the coating composition is applied in step (a) by an application method suitable for applying liquid compositions to a surface of an article. Such methods include, for example, wiping with a cloth, wiping with a sponge, dip coating, spray coating, flow coating, roller coating, slit coating, slot coating, spin coating, dispensing, screen printing, stencil printing or ink-jet printing. Dip coating and spray coating are particularly preferred.

The coating composition of the present invention may be applied to the surface of various articles such as, for example, buildings, dentures, furnishings, furniture, sanitary equipment (toilets, sinks, bathtubs, etc.), signs, signboard, plastic products, glass products, ceramics products, metal products, wood products and vehicles (road vehicles, rail vehicles, watercrafts and aircrafts). It is preferred that the surface of the article is made of any one of the base materials as described for the use below.

Typically, the coating composition is applied in step (a) as a layer in a thickness of 0.1 μm to 100 μm, preferably 0.5 μm to 50 μm, to the surface of the article. In a preferred embodiment, the coating composition is applied as a thin layer having a thickness of 1 to 30 μm.

The curing of the coating in step (b) may be carried out under various conditions such as e.g. by ambient curing, thermal curing and/or irradiation curing. The curing is optionally carried out in the presence of moisture, preferably in the form of water vapor. For this purpose, a climate chamber may be used.

Ambient curing preferably takes place at temperatures in the range from 10 to 40° C. Thermal curing preferably takes place at temperatures in the range from 100 to 200° C., preferably from 120 to 180° C. Irradiation curing preferably takes place with IR irradiation or UV irradiation. Preferred IR irradiation wavelengths are in the range from 7 to 15 μm or from 1 to 3 μm for substrate absorption. Preferred UV irradiation wavelengths are in the range from 300 to 500 nm.

Preferably, the curing in step (b) is carried out in a furnace or climate chamber. Alternatively, if articles of very large size are coated (e.g. buildings, vehicles, etc.), the curing is preferably carried out under ambient conditions.

Preferably, the curing time for step (b) is from 0.01 to 24 h, more preferably from 0.10 to 16 h, still more preferably from 0.15 to 8 h, and most preferably from 0.20 to 5 h, depending on the coating composition and coating thickness.

Other preferred curing conditions are:
1. Thermal curing in the presence of a catalyst such as, e.g. peroxides or sulfur compounds (vulcanization).
2. UV curing in the presence of UV active photoinitiators.

After the curing in step (b), the coating composition is chemically crosslinked to form a hard coating on the surface of the article.

The coating obtained by the above method is a hard coating with maximum mechanical resistance and durability such as maximum surface hardness, scratch resistance and abrasion resistance. Moreover, adverse behavior such as formation of turbid films and wetting problems is avoided.

Article

Moreover, a coated article is provided, which is obtainable or obtained by the above-mentioned preparation method.

Use

The present invention further relates to the use of the coating composition according to the present invention for forming a hard coating on the surface of a base material.

Preferred base materials, to which the coating composition according to the present invention is applied, include a wide variety of materials such as, for example, metals (such as iron, steel, silver, zinc, aluminum, nickel, titanium, vanadium, chromium, cobalt, copper, zirconium, niobium, molybdenum, ruthenium, rhodium, silicon, boron, tin, lead or manganese or alloys thereof provided, if necessary, with an oxide or plating film); plastics (such as polymethyl methacrylate (PMMA), polyurethane, polyesters (PET), polyallyldiglycol carbonate (PADC), polycarbonate, polyimide, polyamide, epoxy resin, ABS resin, polyvinyl chloride, polyethylene (PE), polypropylene (PP), polythiocyanate, or polytetrafluoroethylene (PTFE)); glass (such as fused quartz, soda-lime-silica glass (window glass), sodium borosilicate glass (Pyrex®), lead oxide glass (crystal glass), aluminosilicate glass, or germanium-oxide glass); and construction materials (such as brick, cement, ceramics, clay, concrete, gypsum, marble, mineral wool, mortar, stone, or wood and mixtures thereof).

The base materials may be treated with a primer to enhance adhesion of the hard coating. Such primers are, for example, silanes, siloxanes, or silazanes. If plastic materials are used, it may be advantageous to perform a pretreatment by flaming, corona or plasma treatment which might improve the adhesion of the functional coating. If construction materials are used, it may be advantageous to perform a precoating with lacquers, varnishes or paints such as, for example, polyurethane lacquers, acrylic lacquers and/or dispersion paints.

The present invention is further illustrated by the examples following hereinafter which shall in no way be construed as limiting. The skilled person will acknowledge that various modifications, additions and alternations may be made to the invention without departing from the spirit and scope of the present invention.

### EXAMPLES

Used Raw Materials

In the examples described herein, the following raw materials were used:
DBU [1,8-Diazabicyclo[5.4.0]undc-7-ene], available from Sigma-Aldrich. n-Butyl acetate in water-free quality, available from Sigma-Aldrich.
Nanopol® C 784, 50 wt.-% in butyl acetate, average particle size 20 nm, colloidal silica, available from Evonik.
3-Aminopropyltriethoxysilane (AMEO), available from Sigma-Aldrich:

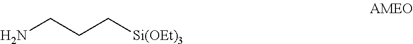

Bis[3-(trimethoxysilyl)propyl]amine (AMEO-Dimer), available from Sigma-Aldrich:

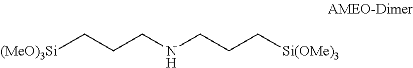

Durazane® 1000: n:m=0:100, Durazane® 1033: n:m=33:67,
Durazane® 1066: n:m=66:34, Durazane® 1085: n:m=85:15, all available from Merck KGaA:

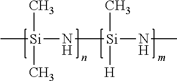

I. Preparation of formulations comprising Durazane® as silazane polymer (A) and AMEO as silane coupling agent (B)

Formulations comprising Durazane® as silazane polymer (A) and AMEO as silane coupling agent (B) were prepared according to the following general procedure. The exact amounts used are shown in Table 1:

First, AMEO was mixed with the solvent n-butyl acetate. Then Durazane® was added. The formulation was intensively stirred for 8 h and finally a clear solution was obtained.

TABLE 1
Composition of formulations 1-A1 to 1-D6.

| | Silazane | | | m(n-Butyl |
|---|---|---|---|---|
| Formulation | Polymer | m(Durazane ®) | m(AMEO) | acetate) |
| No. | Durazane ® | [g] | [g] | [g] |
| 1-A1 | 1000 | 90 | 10 | 100 |
| 1-A2 | 1000 | 80 | 20 | 100 |
| 1-A3 | 1000 | 70 | 30 | 100 |
| 1-A4 | 1000 | 60 | 40 | 100 |
| 1-A5 | 1000 | 50 | 50 | 100 |
| 1-A6 | 1000 | 40 | 60 | 100 |
| 1-B1 | 1033 | 90 | 10 | 100 |
| 1-B2 | 1033 | 80 | 20 | 100 |
| 1-B3 | 1033 | 70 | 30 | 100 |
| 1-B4 | 1033 | 60 | 40 | 100 |
| 1-B5 | 1033 | 50 | 50 | 100 |
| 1-B6 | 1033 | 40 | 60 | 100 |
| 1-C1 | 1066 | 90 | 10 | 100 |
| 1-C2 | 1066 | 80 | 20 | 100 |
| 1-C3 | 1066 | 70 | 30 | 100 |
| 1-C4 | 1066 | 60 | 40 | 100 |
| 1-C5 | 1066 | 50 | 50 | 100 |
| 1-C6 | 1066 | 40 | 60 | 100 |
| 1-D1 | 1085 | 90 | 10 | 100 |
| 1-D2 | 1085 | 80 | 20 | 100 |
| 1-D3 | 1085 | 70 | 30 | 100 |
| 1-D4 | 1085 | 60 | 40 | 100 |
| 1-D5 | 1085 | 50 | 50 | 100 |
| 1-D6 | 1085 | 40 | 60 | 100 |

II. Preparation of formulations comprising Durazane® as silazane polymer (A), AMEO-Dimer as silane coupling agent (B) and DBU

Formulations comprising Durazane® as silazane polymer (A), AMEO-Dimer as silane coupling agent (B) and DBU were prepared according to the following general procedure. The exact amounts used are shown in Table 2:

First, AMEO-Dimer was mixed with the solvent n-butyl acetate, then DBU was added and the formulation was intensively stirred for 4 h. Then Durazane® was added and the formulation was intensively stirred for another 8 h. Finally, a clear solution was obtained.

TABLE 2
Composition of formulations 2-A1 to 2-D6.

| | Silazane | | m(AMEO- | | m(n-Butyl |
|---|---|---|---|---|---|
| Formulation | Polymer | m(Durazane ®) | Dimer) | m(DBU) | acetate) |
| No. | Durazane ® | [g] | [g] | [g] | [g] |
| 2-A1 | 1000 | 90 | 10 | 1 | 99 |
| 2-A2 | 1000 | 80 | 20 | 1 | 99 |
| 2-A3 | 1000 | 70 | 30 | 1 | 99 |
| 2-A4 | 1000 | 60 | 40 | 1 | 99 |
| 2-A5 | 1000 | 50 | 50 | 1 | 99 |
| 2-A6 | 1000 | 40 | 60 | 1 | 99 |
| 2-B1 | 1033 | 90 | 10 | 1 | 99 |
| 2-B2 | 1033 | 80 | 20 | 1 | 99 |
| 2-B3 | 1033 | 70 | 30 | 1 | 99 |
| 2-B4 | 1033 | 60 | 40 | 1 | 99 |
| 2-B5 | 1033 | 50 | 50 | 1 | 99 |
| 2-B6 | 1033 | 40 | 60 | 1 | 99 |
| 2-C1 | 1066 | 90 | 10 | 1 | 99 |
| 2-C2 | 1066 | 80 | 20 | 1 | 99 |
| 2-C3 | 1066 | 70 | 30 | 1 | 99 |
| 2-C4 | 1066 | 60 | 40 | 1 | 99 |
| 2-C5 | 1066 | 50 | 50 | 1 | 99 |
| 2-C6 | 1066 | 40 | 60 | 1 | 99 |
| 2-D1 | 1085 | 90 | 10 | 1 | 99 |
| 2-D2 | 1085 | 80 | 20 | 1 | 99 |
| 2-D3 | 1085 | 70 | 30 | 1 | 99 |
| 2-D4 | 1085 | 60 | 40 | 1 | 99 |
| 2-D5 | 1085 | 50 | 50 | 1 | 99 |
| 2-D6 | 1085 | 40 | 60 | 1 | 99 |

III. Preparation of formulations comprising Durazane® as silazane polymer (A), AMEO-Dimer as silane coupling agent (B) and inorganic nanoparticles (C)

Formulations comprising Durazane® as silazane polymer (A), AMEO as silane coupling agent (B) and inorganic nanoparticles (C) were prepared according to the following general procedure. The exact amounts used are shown in Table 3:
First, AMEO was mixed with the solvent n-butyl acetate, then inorganic nanoparticles were added and the formulation was intensively stirred for 4 h. Then Durazane® was added and the formulation was intensively stirred for another 4 h. Finally, a clear to slightly opalescent solution was obtained.

TABLE 3
Composition of formulations 3-A1 to 3-C5.

| | Silazane | | | M(Nanopol | m(n-Butyl |
|---|---|---|---|---|---|
| Formulation | Polymer | m(Durazane ®) | m(AMEO) | (@50%)) | acetate) |
| No. | Durazane ® | [g] | [g] | [g] | [g] |
| 3-A1 | 1033 | 70 | 30 | 80 | 100 |
| 3-A2 | 1033 | 70 | 30 | 120 | 100 |
| 3-A3 | 1033 | 70 | 30 | 160 | 100 |
| 3-A4 | 1033 | 70 | 30 | 200 | 100 |
| 3-A5 | 1033 | 70 | 30 | 240 | 100 |
| 3-B1 | 1033 | 60 | 40 | 80 | 100 |
| 3-B2 | 1033 | 60 | 40 | 120 | 100 |
| 3-B3 | 1033 | 60 | 40 | 160 | 100 |
| 3-B4 | 1033 | 60 | 40 | 200 | 100 |
| 3-B5 | 1033 | 60 | 40 | 240 | 100 |
| 3-C1 | 1033 | 50 | 50 | 80 | 100 |
| 3-C2 | 1033 | 50 | 50 | 120 | 100 |
| 3-C3 | 1033 | 50 | 50 | 160 | 100 |
| 3-C4 | 1033 | 50 | 50 | 200 | 100 |
| 3-C5 | 1033 | 50 | 50 | 240 | 100 |

IV. Application

All formulations were spin coated on 10 cm×10 cm glass plates. The rotation speed of the spin coater was adjusted between 250 and 2,000 rpm to achieve a film thickness of 2.0-2.5 μm. All coated glass plates were cured under ambient conditions at a temperature of 25° C. and a relative humidity of 50% for 14 days.

Measurement and evaluation of the coatings performance:
After curing for 14 days all coatings were analyzed visually with the bare eye on turbidity, inhomogeneity, cracks, delamination and other obvious film defects. The hardness of the coating was analyzed with a Nanoindenter [Nanoindenter model Helmut Fisher FISCHERSCOPE HM2000 S, Vickers diamond pyramid] according to DIN EN ISO 14577-1/ASTM E 2546. The results are shown in Tables 4, 5 and 6.

TABLE 4
Analytical results Exp. 1-A1-Exp. 1-D6 of coatings
derived from formulations 1-A1 to 1-D6.

| | | | Nanoindenter | |
|---|---|---|---|---|
| | | Weight ratio | Martens | |
| Experiment | Formulation | Durazane ® | Hardness | Visual |
| No. | No. | XXX:AMEO | [MPa] | observation |
| Exp. 1-A1 | 1-A1 | 1000:AMEO = 90:10 | 131 | Ok |
| Exp. 1-A2 | 1-A2 | 1000:AMEO = 80:20 | 157 | Ok |
| Exp. 1-A3 | 1-A3 | 1000:AMEO = 70:30 | 207 | Ok |
| Exp. 1-A4 | 1-A4 | 1000:AMEO = 60:40 | 253 | Ok |
| Exp. 1-A5 | 1-A5 | 1000:AMEO = 50:50 | 301 | Ok |
| Exp. 1-A6 | 1-A6 | 1000:AMEO = 40:60 | — | wetting |
| | | | | defects |
| Exp. 1-B1 | 1-B1 | 1033:AMEO = 90:10 | 77 | Ok |
| Exp. 1-B2 | 1-B2 | 1033:AMEO = 80:20 | 118 | Ok |
| Exp. 1-B3 | 1-B3 | 1033:AMEO = 70:30 | 158 | Ok |
| Exp. 1-B4 | 1-B4 | 1033:AMEO = 60:40 | 204 | Ok |
| Exp. 1-B5 | 1-B5 | 1033:AMEO = 50:50 | 244 | Ok |
| Exp. 1-B6 | 1-B6 | 1033:AMEO = 40:60 | — | wetting |
| | | | | defects |
| Exp. 1-C1 | 1-C1 | 1066:AMEO = 90:10 | 30 | Ok |
| Exp. 1-C2 | 1-C2 | 1066:AMEO = 80:20 | 61 | Ok |
| Exp. 1-C3 | 1-C3 | 1066:AMEO = 70:30 | 89 | Ok |
| Exp. 1-C4 | 1-C4 | 1066:AMEO = 60:40 | 124 | Ok |
| Exp. 1-C5 | 1-C5 | 1066:AMEO = 50:50 | 162 | Ok |
| Exp. 1-C6 | 1-C6 | 1066:AMEO = 40:60 | — | wetting |
| | | | | defects |
| Exp. 1-D1 | 1-D1 | 1085:AMEO = 90:10 | 13 | Ok |
| Exp. 1-D2 | 1-D2 | 1085:AMEO = 80:20 | 33 | Ok |
| Exp. 1-D3 | 1-D3 | 1085:AMEO = 70:30 | 54 | Ok |
| Exp. 1-D4 | 1-D4 | 1085:AMEO = 60:40 | 86 | Ok |
| Exp. 1-D5 | 1-D5 | 1085:AMEO = 50:50 | 123 | Ok |
| Exp. 1-D6 | 1-D6 | 1085:AMEO = 40:60 | — | wetting |
| | | | | defects |

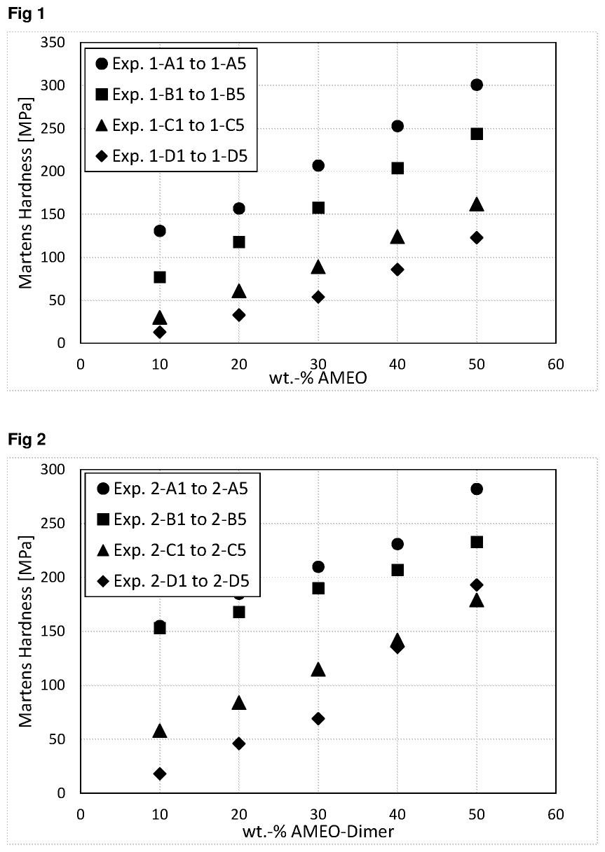

The results in Table 4 and FIG. 1 show an almost linear increase in hardness with increasing amount of AMEO. However, if the amount of AMEO reaches 60 wt.-%, the coatings show wetting defects and do not form a closed film anymore. Regarding the type of Durazane®, the higher the amount of —[Si(H)CH₃—NH]— monomer units in the polymer is, the higher is the Nanoindenter Martens hardness.

TABLE 5
Analytical results Exp. 2-A1-Exp. 2-D6 of coatings
derived from formulations 2-A1 to 2-D6.

| | | | Nanoindenter | |
|---|---|---|---|---|
| | | Weight ratio | Martens | |
| Experiment | Formulation | Durazane ® | Hardness | Visual |
| No. | No. | XXX:AMEO-Dimer | [MPa] | observation |
| Exp. 2-A1 | 2-A1 | 1000:AMEO-Dimer = 90:10 | 155 | Ok |
| Exp. 2-A2 | 2-A2 | 1000:AMEO-Dimer = 80:20 | 185 | Ok |
| Exp. 2-A3 | 2-A3 | 1000:AMEO-Dimer = 70:30 | 210 | Ok |
| Exp. 2-A4 | 2-A4 | 1000:AMEO-Dimer = 60:40 | 231 | Ok |
| Exp. 2-A5 | 2-A5 | 1000:AMEO-Dimer = 50:50 | 282 | Ok |
| Exp. 2-A6 | 2-A6 | 1000:AMEO-Dimer = 40:60 | — | wetting |
| | | | | defects |
| Exp. 2-B1 | 2-B1 | 1033:AMEO-Dimer = 90:10 | 153 | Ok |
| Exp. 2-B2 | 2-B2 | 1033:AMEO-Dimer = 80:20 | 168 | Ok |
| Exp. 2-B3 | 2-B3 | 1033:AMEO-Dimer = 70:30 | 190 | Ok |
| Exp. 2-B4 | 2-B4 | 1033:AMEO-Dimer = 60:40 | 207 | Ok |
| Exp. 2-B5 | 2-B5 | 1033:AMEO-Dimer = 50:50 | 233 | Ok |
| Exp. 2-B6 | 2-B6 | 1033:AMEO-Dimer = 40:60 | — | wetting |
| | | | | defects |
| Exp. 2-C1 | 2-C1 | 1066:AMEO-Dimer = 90:10 | 58 | turbid |
| Exp. 2-C2 | 2-C2 | 1066:AMEO-Dimer = 80:20 | 84 | turbid |
| Exp. 2-C3 | 2-C3 | 1066:AMEO-Dimer = 70:30 | 115 | Ok |
| Exp. 2-C4 | 2-C4 | 1066:AMEO-Dimer = 60:40 | 142 | Ok |
| Exp. 2-C5 | 2-C5 | 1066:AMEO-Dimer = 50:50 | 179 | Ok |
| Exp. 2-C6 | 2-C6 | 1066:AMEO-Dimer = 40:60 | — | wetting |
| | | | | defects |
| Exp. 2-D1 | 2-D1 | 1085:AMEO-Dimer = 90:10 | 18 | turbid |
| Exp. 2-D2 | 2-D2 | 1085:AMEO-Dimer = 80:20 | 46 | turbid |
| Exp. 2-D3 | 2-D3 | 1085:AMEO-Dimer = 70:30 | 69 | turbid |
| Exp. 2-D4 | 2-D4 | 1085:AMEO-Dimer = 60:40 | 135 | turbid |
| Exp. 2-D5 | 2-D5 | 1085:AMEO-Dimer = 50:50 | 193 | turbid |
| Exp. 2-D6 | 2-D6 | 1085:AMEO-Dimer = 40:60 | — | turbid and |
| | | | | wetting |
| | | | | defects |

Similar to Table 4/FIG. 1, Table 5/FIG. 2 show an almost linear increase in hardness with increasing amount of AMEO-Dimer. In contrast to AMEO, the dimeric AMEO-Dimer has a higher effect when used in lower amounts. However, if the amount of AMEO reaches 60 wt.-%, the coatings show wetting defects and do not form a closed film anymore. When mixed with Durazane® containing higher amount of —[Si(CH₃)₂—NH]— monomer units (Durazane® 1066 and Durazane® 1085), turbid films are formed. Regarding the type of Durazane®, again the higher the amount of —[Si(H)CH₃—NH]— monomer units in the polymer is, the higher is the Nanoindenter Martens hardness.

TABLE 6
Analytical results Exp. 3-A1-Exp. 3-C5 of coatings
derived from formulations 3-A1 to 3-C5.

| | | Weight ratio | Nanoindenter | |
|---|---|---|---|---|
| | | Durazane ® | Martens | |
| Experiment | Formulation | (1033):AMEO:Nano- | Hardness | Visual |
| No. | No. | particles(@100%) | [Ma] | observation |
| Exp. 3-A1 | 3-A1 | 1033:AMEO:NP = 70:30:40 | 185 | Ok |
| Exp. 3-A2 | 3-A2 | 1033:AMEO:NP = 70:30:60 | 199 | Ok |
| Exp. 3-A3 | 3-A3 | 1033:AMEO:NP = 70:30:80 | 228 | Ok |
| Exp. 3-A4 | 3-A4 | 1033:AMEO:NP = 70:30:100 | 254 | Ok |
| Exp. 3-A5 | 3-A5 | 1033:AMEO:NP = 70:30:120 | — | cracks |
| Exp. 3-B1 | 3-B1 | 1033:AMEO:NP = 60:40:40 | 244 | Ok |
| Exp. 3-B2 | 3-B2 | 1033:AMEO:NP = 60:40:60 | 267 | Ok |
| Exp. 3-B3 | 3-B3 | 1033:AMEO:NP = 60:40:80 | 278 | Ok |
| Exp. 3-B4 | 3-B4 | 1033:AMEO:NP = 60:40:100 | 312 | Ok |
| Exp. 3-B5 | 3-B5 | 1033:AMEO:NP = 60:40:120 | — | cracks |
| Exp. 3-C1 | 3-C1 | 1033:AMEO:NP = 50:50:40 | 288 | Ok |
| Exp. 3-C2 | 3-C2 | 1033:AMEO:NP = 50:50:60 | 302 | Ok |
| Exp. 3-C3 | 3-C3 | 1033:AMEO:NP = 50:50:80 | 320 | Ok |
| Exp. 3-C4 | 3-C4 | 1033:AMEO:NP = 50:50:100 | 339 | Ok |
| Exp. 3-C5 | 3-C5 | 1033:AMEO:NP = 50:50:120 | — | cracks |

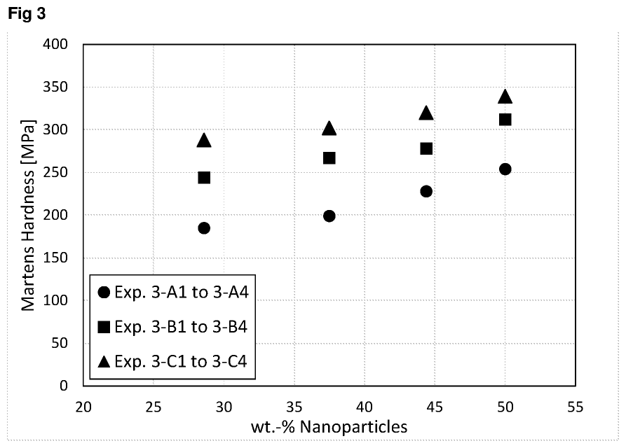

Table 6 and FIG. 3 show an almost linear increase in hardness with increasing amount of Nanoparticles for all the three Durazane® 1033 :
AMEO ratios. However, if the amount of Nanoparticles reaches 60 wt.-%, the coatings form cracks after curing.

In summary, the following general conclusions can be drawn:
1. A higher ratio of —[Si(H)CH₃—NH]— monomer units in the Durazane® polymer results in harder coatings.
2. A higher amount of silane coupling agent relative to the Durazane® polymer results in harder coatings. However, if the amount of silane coupling agent exceeds, the coating shows film defects.
3. A higher amount of Nanoparticles relative to the sum of the Durazane® polymer and the silane coupling agent results in harder coatings. However, if the amount of Nanoparticles exceeds 60%, the coating shows film defects.

1. A coating composition, comprising:
a silazane polymer (A);
a silane coupling agent (B); and
inorganic nanoparticles (C);
wherein the weight ratio [A]:[B] of the silazane polymer (A) to the silane coupling (B) is in the range from 75:25 to 40:60, and the weight ratio [A+B]:[C] of the silazane polymer (A) and the silane coupling agent (B) to the inorganic nanoparticles (C) is in the range from 80:20 to 50:50.

2. The coating composition according to claim 1, wherein the weight ratio [A]:[B] of the silazane polymer (A) to the silane coupling (B) is in the range from 66:34 to 45:55, and the weight ratio [A+B]:[C] of the silazane polymer (A) and the silane coupling agent (B) to the inorganic nanoparticles (C) is in the range from 73:27 to 55:45.

3. The coating composition according to claim 1, wherein the weight ratio [A]:[B] of the silazane polymer (A) to the silane coupling (B) is in the range from 60:40 to 50:50, and the weight ratio [A+B]:[C] of the silazane polymer (A) and the silane coupling agent (B) to the inorganic nanoparticles (C) is in the range from 70:30 to 60:40.

4. The coating composition according to claim 1, wherein the silazane polymer (A) comprises a repeating unit M¹ represented by Formula (1):
—[SiR¹R²—NR³—] Formula (1)
wherein R¹, R², R³ are the same or different from each other and independently selected from hydrogen, an organic group, or a hetero-organic group.

5. The coating composition according to claim 4, wherein R¹ and R² are the same or different from each other and independently selected from hydrogen, alkyl having 1 to 30 carbon atoms, alkenyl having 2 to 30 carbon atoms, or aryl having 2 to 30 carbon atoms, wherein one or more hydrogen atoms bonded to carbon atoms may each be replaced by fluorine; and R³ is selected from hydrogen, alkyl having 1 to 30 carbon atoms, alkenyl having 2 to 30 carbon atoms, or aryl having 2 to 30 carbon atoms, wherein one or more hydrogen atoms bonded to carbon atoms may each be replaced by fluorine.

6. The coating composition according to claim 4, wherein the silazane polymer (A) further comprises a repeating unit M² represented by Formula (2):
—[SiR⁴R⁵—NR⁶—] Formula (2)
wherein R⁴, R⁵ and R⁶ are the same or different from each other and independently selected from hydrogen, an organic group, or a hetero-organic group.

7. The coating composition according to claim 6, wherein R⁴ and R⁵ are the same or different from each other and independently selected from hydrogen, alkyl having 1 to 30 carbon atoms, alkenyl having 2 to 30 carbon atoms, or aryl having 2 to 30 carbon atoms, wherein one or more hydrogen atoms bonded to carbon atoms may each be replaced by fluorine; and R⁶ is selected from hydrogen, alkyl having 1 to 30 carbon atoms, alkenyl having 2 to 30 carbon atoms, or aryl having 2 to 30 carbon atoms, wherein one or more hydrogen atoms bonded to carbon atoms may each be replaced by fluorine.

8. The coating composition according to claim 1, wherein the silane coupling agent (B) comprises one or more alkoxy silyl groups.

9. The coating composition according to claim 1, wherein the silane coupling agent (B) is represented by Formula (a):
Z[SiR^{I}₃₋ₖR^{II}ₖ]ₙ Formula (a)
wherein
Z is a structural unit comprising one or more carbon and/or silicon atoms;
R^{I} is at each occurrence independently from each other a linear alkoxy group having 1 to 20 carbon atoms, a branched alkoxy group having 3 to 20 carbon atoms, or a cyclic alkoxy group having 3 to 20 carbon atoms, which optionally contains one or more —O— and/or —Si(CH₃)₂-groups;
R^{II} is at each occurrence independently from each other a linear alkyl group having 1 to 20 carbon atoms, a branched alkyl group having 3 to 20 carbon atoms, or a cyclic alkyl group having 3 to 20 carbon atoms;
k is 0, 1 or 2; and
n is 1, 2, 3 or 4.

10. The coating composition according to claim 1, wherein the silane coupling agent (B) is represented by one of Formulae (b) to (e): 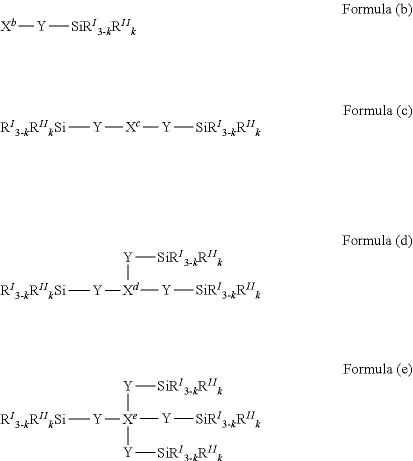
wherein
X^{b} is selected from (CH₃)₂N—, [HO—(CH₂)ₘ]₂N—, AcO—, CH₃(CH₂)ₘ—NH—, CH₃—NH—, Cl—, H₂C═C(CH₃)—CH₂—NH—, H₂C═C(CH₃)—CO—O—, H₂C═C(CH₃) —O—CH₂—CH(OH)—CH₂—NH—, H₂C═CH—, H₂C═CH—CH₂—NH—, H₂C═CH—CO—CH₂—CH(OH)-CH₂—NH—, H₂C═CH—CO—O—, H₂N—, H₂N—(CH₂)ₘ—NH—, H₂N—(CH₂)ₘ—NH—(CH₂)ₙ—, H₂N—(CH₂)ₘ—NH—(CH₂)ₙ—NH—, H₂N—(CH₂)ₘ—NH—C₄H₆—, H₂N—(CH₂)ₘNH—CH₂—C₄H₆—, H₂N—(CH₂)ₘ—O—C(CH₃)₂—CH═CH—, H₂N—C₆H₄—, H₂N—C₆H₄—O—, H₃C—, H₃C—(CH₂)ₘ—, H₃C—(CH₂)ₘ—O—, H₃CO—, HO—, HS—, NCS—, Ph₂N—, Ph—CO—O—, Ph—NH—, and 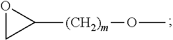
m is an integer from 1 to 10;
n is an integer from 1 to 10;
X^{c} is selected from (CH₂)ₚ—, —NH—, NH—(CH₂)ₚ—NH—, —O—, —S—, —S₂—, —S₃—, —S₄—, —Si(CH₃)₂—, and —Si(CH₃)₂—O—Si(CH₃)₂—;
p is an integer from 1 to 20;
X^{d} is selected 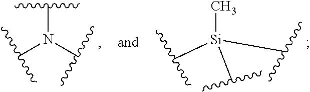
X^{e} is 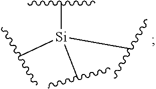 [SMILES: *[Si](*)(*)*]
Y is absent or a linear alkylene group having 1 to 20 carbon atoms, a branched alkylene group having 3 to 20 carbon atoms, or a cyclic alkylene group having 3 to 20 carbon atoms;
R^{I} is at each occurrence independently from each other a linear alkoxy group having 1 to 20 carbon atoms, a branched alkoxy group having 3 to 20 carbon atoms, or a cyclic alkoxy group having 3 to 20 carbon atoms, which optionally contains one or more —O— and/or —Si(CH₃)₂- groups;
R^{II} is at each occurrence independently from each other a linear alkyl group having 1 to 20 carbon atoms, a branched alkyl group having 3 to 20 carbon atoms, or a cyclic alkyl group having 3 to 20 carbon atoms; and
k is 0, 1 or 2.

11. The coating composition according to claim 1, wherein the silane coupling agent (B) is selected from:
(i) monofunctional silane coupling agents selected from
(3-acryloxypropyl)dimethylmethoxysilane,
(3-acryloxypropyl)methyldimethoxysilane,
(3-acryloxypropyl)trimethoxysilane,
(aminoethylaminomethyl)phenethyltrimethoxysilane,
(methacryloxymethyl)dimethylethoxysilane,
3-(2-aminoethylamino)propylmethyldiethoxysilane,
3-(2-aminoethylamino)propyltrimethoxysilane,
3-(3-aminopropoxy)-3,3-dimethyl-1-propenyl-trimethoxysilane,
3-(m-aminophenoxy)propyltrimethoxysilane,
3-(N-allylamino)propyltrimethoxysilane,
3-(trimethoxysilyl)-1-propanethiol, 3-aminopropyldimethylethoxysilane, 3-aminopropylmethyldiethoxysilane, 3-aminopropylmethyldimethoxysilane,
3-aminopropyltriethoxysilane, 3-aminopropyltrimethoxysilane,
3-aminopropyltris(methoxyethoxyethoxy)silane,
3-chloropropyltrimethoxysilane, 3-glycidyloxypropyltriethoxysilane,
3-glycidyloxypropyltrmethoxysilane,
3-methacryloxypropyldimethylethoxysilane,
3-methacryloxypropyltriethoxysilane,
3-methacryloxypropyltris(methoxyethoxy)silane,
4-aminobutyltriethoxysilane,
6-ethyl-6-(2-methoxyethoxy)-2,5,7,10-tetraoxa-6-silaundecane, acetoxymethyltriethoxysilane, acetoxymethyltrimethoxysilane, acetoxypropyltrimethoxysilane, benzoyloxypropyltrimethoxysilane, hydroxymethyltriethoxysilane, m-aminophenyltrimethoxysilane, methacryloxymethyltriethoxysilane, methacryloxymethyltrimethoxysilane,
N-(2-aminoethyl)-3-aminoisobutylmethyldimethoxysilane,
N-(2-aminoethyl)-3-aminopropylmethyldimethoxysilane,
N-(2-aminoethyl)-3-aminopropyltrimethoxysilane,
N-(3-acryloxy-2-hydroxypropyl)-3-aminopropyltriethoxysilane,
N-(6-aminohexyl)aminopropyltrimethoxysilane,
N-(n-butyl)-3-aminopropyltrimethoxysilane,
N,N-bis(2-hydroxyethyl)-3-aminopropyltriethoxysilane,
N¹-(3-trimethoxysilylpropyl)diethylenetriamine,
N-methylaminopropylmethyldimethoxysilane,
N-methylaminopropyltrimethoxysilane,
N-phenylaminomethyltriethoxysilane,
N-phenylaminopropyltrimethoxysilane,
p-aminophenyltrimethoxysilane, tetraethoxysilane,
triethoxy(3-thiocyanato)propylsilane, triethoxy(octyl)silane, and
trimethoxymethylsilane, and vinyltriethoxysilane;
(ii) difunctional silane coupling agents selected from
1-(triethoxysilyl)-2-(diethoxymethylsilyl)ethane,
1-(trimethoxysilyl)-2-(dimethylmethoxysilyl)ethane,
1-(trimethoxysilyl)-2-(methyldimethoxysilyl)ethane,
1,2-bis(dimethylmethoxysilyl)ethane,
1,2-bis(methyldimethoxysilyl)ethane,
1,2-bis(trimethoxysilyl)ethane,
1,3-bis(triethoxysilylethyl)-1,1,3,3-tetramethyldisiloxane,
1,3-bis(trimethoxysilylethyl)-1,1,3,3-tetramethyldisiloxane,
1,6-bis(triethoxysilyl)hexane, 1,6-bis(trimethoxysilyl)hexane,
1,8-bis(triethoxysilyl)octane, 1,8-bis(trimethoxysilyl)octane,
bis(3-(triethoxysilyl)-1-propyl)disulfide,
bis(3-(trimethoxysilyl)-1-propyl)disulfide,
bis(3-(trimethoxysilyl)-1-propyl)tetrasulfide,
bis[2-(triethoxysilyl)ethyl]dimethylsilane,
bis[3-(triethoxysilyl)propyl]amine, bis[3-(triethoxysilyl)propyl]sulfide, bis[2-(trimethoxysilyl)ethyl]dimethylsilane,
bis[3-(trimethoxysilyl)propyl]amine,
bis[3-(trimethoxysilyl)propyl]sulfide,
bis[3-(triethoxysilyl)propyl]ether, bis[3-(trimethoxysilyl)propyl]ether, and
N,N′-bis[3-(trimethoxysilyl)propyl]ethylenediamine;
(iii) trifunctional silane coupling agents selected from
tris(triethoxysilylethyl)methylsilane,
tris(triethoxysilylethyldimethylsiloxy)methylsilane,
tris(triethoxysilylpropyl)amine, tris(triethoxysilylpropyl)methylsilane,
tris(trimethoxysilylethyl)methylsilane,
tris(trimethoxysilylethyldimethylsiloxy)methylsilane,
tris(trimethoxysilylpropyl)amine, and
tris(trimethoxysilylpropyl)methylsilane; and
(iv) tetrafunctional silane coupling agents selected from
tetrakis(triethoxysilylethyl)silane, tetrakis(triethoxysilylpropyl)silane, and
tetrakis(trimethoxysilylpropyl)silane.

12. The coating composition according to claim 1, wherein the inorganic nanoparticles (C) are selected from carbides, diamond, nitrides, oxides, silicates, sulfates, sulfides, sulfites, and titanates which are optionally surface-modified with a capping agent.

13. The coating composition according to claim 1, wherein the inorganic nanoparticles (C) are selected from boron carbide, silicon carbide, titanium carbide, tungsten carbide, diamond, boron nitride, silicon nitride, titanium nitride, aluminum oxide, molybdenum oxide, silica, titania and zirconia.

14. The coating composition according to claim 1, wherein the inorganic nanoparticles (C) have a particle diameter in the range from 1 to 100 nm, more preferably from 5 to 60 nm, even more preferably from 10 to 40 nm, and most preferably from 10 to 25 nm.

15. The coating composition according to claim 1, wherein the coating composition further comprises one or more solvents.

16. A method for preparing a coated article, wherein the method comprises:
(a) applying a coating composition according to claim 1 to a surface of an article; and
(b) curing said coating composition to obtain a coated article.

17. A coated article, obtainable by the method according to claim 16.

18. A method for preparing a hard coating on a surface of a base material, comprising apply a coating composition according to claim 1 to a surface of a base material.

19. The coating composition according to claim 1, wherein the inorganic nanoparticles (C) have a particle diameter in the range from 5 to 60 nm

20. The coating composition according to claim 1, wherein the inorganic nanoparticles (C) have a particle diameter in the range from 10 to 40 nm.
